(19) United States
(12) Patent Application Publication
(10) Pub. No.: US 2003/0159066 A1
(43) Pub. Date: Aug. 21, 2003

(54) Method and apparatus for network user location verification

(75) Inventors: Michael Staw, Atlanta, GA (US); Federico Schravio, Marina Del Ray, CA (US)

Correspondence Address: GREENBERG-TRAURIG, 1750 TYSONS BOULEVARD, 12TH FLOOR, MCLEAN, VA, 22102, US

(73) Assignee: KDMS International LLC, Atlanta, GA

(21) Appl. No.: 10/076,066

(22) Filed: Feb. 15, 2002

(51) Int. Cl. H04L 9/00

(52) U.S. Cl. 713/201; 380/258

(57) ABSTRACT

A user desiring to conduct a transaction provided by a transaction server first establishes a location identifiable connection via communications medium with a verification server. The verification server identifies the location of the user, and provides a location identification to the transaction server. The communications medium between the user and the verification server may be a telephone connection that provides an Automatic Number Identification (ANI) providing at least an area code to the verification server. The connection between the user and the transaction server may be provided by higher speed link than the connection between the user and the verification server.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of access control, and in particular to a system and method for verification of the location of a network user in connection with conducting a transaction.

### BACKGROUND OF THE INVENTION

The Internet, and other modern computer networks have made it possible to conduct transactions without almost any regard for the location of the transacting parties. Often, when users use the Internet or other computer networks, the users are unaware of the physical location of the computer they have connected to. Similarly, the computer providing the services or data is unaware of the location of the user.

Many technologies are currently used and more have been proposed to permit users to access computers from remote locations. Generally speaking, such technologies include a user identification and a passcode. In rudimentary access control systems, a user is asked to type a user identifer and a passcode. More sophisticated systems may use, as the passcode, a biometric identifier or the output of a random number generator that is synchronized in various manners to the computer being accessed. Where the passcode of the user is authenticated, the user may be permitted access. In more sophisticated systems, controls may additional be placed on users or groups relating to the time of day or day of the week.

Systems that permit users to access a computer from a remote location could permit access over conventional telephone lines, but more recently they also permit access across the Internet or other computer networks—which latter access may, but does not necessarily, involve the user of telephone lines. In other words, some computers access the Internet or other computer networks using a modem to modulate the transmissions over the telephone lines, while others access such networks using other technologies that do not require modulation over telephone lines. Examples of the latter include the so-called cable modem and/or DSL modem, and, for example, wireless 802.11 technologies.

In any event, once permitted access to a hosting computer, the user cannot determine where the host computer is located, and the host computer cannot determine where the user is located. This is particularly problematic where the transactions or services being provided by the host are desired to be, or legally must be, geographically restricted. For example, a host transaction provider may desire to offer gambling transactions that are legal in one geographic location, but not in another. Similarly, a host transaction provider may desire to sell hard goods or information products at prices that vary based upon the purchaser's location; or such a host transaction provider may be licensed to sell goods or information to purchasers in some locations, but not in others. Another example involves the sale of software by download where the software is restricted in locations to which it may be exported—or imported. There may also be information or other content that is inappropriate for consumption in one jurisdiction, while perfectly appropriate in another.

What is needed is a method and apparatus for verifying the location of a network user when the network user is attempting to engage a transaction server in a location-dependent transaction.

### OBJECTS AND SUMMARY OF THE INVENTION

It is therefore an object of the invention to provide a system and method for access control for a transaction or system based upon the location of a user.

It is a further object of the invention to provide an access control system and method that can prevent access to a computer by users in pre-specified locations.

It is another object of the invention to provide an access control system that can restrict access to programs or content from users that are in jurisdictions where such programs and/or content are not permitted by law.

It is yet another object of the invention to provide a method and system for location verification and monitoring for a computer system user.

It is even a further object of the invention to provide a method and system that can provide a user in a given location access to certain transactions, but not permit that same user in the same location access to other transactions.

In a preferred embodiment, the invention provides a transaction authorization system for authorizing a transaction between a user computer and a transaction processor if the user computer is in a pre-specified location, the system comprising: a location verification server for receiving a location verification request from a user computer desiring authorization to conduct a transaction with a transaction server, the location verification server including a location identification system for obtaining a location-related identifier associated with the source of the location verification request, and a message constructor for encoding the location-related identifier into a message; a transaction server adapted to receive the message, the transaction server including a message decoder for decoding the location-related identifier encoded within the message, and a transaction authorizer system for authorizing a transaction between the user computer and the transaction processor if the pre-specified location comprises the location identified by the location-related identifier; and a message transmit facility for transporting the message from the location verification server to the transaction server.

In another preferred embodiment, the invention provides a transaction processing system for conducting a location-dependent transaction between a user and a transaction server if the user is in a pre-specified location, the system comprising: a verification server for receiving an incoming telephone call from a user desiring to conduct a location-dependent transaction with a transaction server, the verification server including a decoder for obtaining a location-related identifier associated with the incoming telephone call, and a location-related message constructor for encoding the location-related identifier into a location-related message; a transaction server adapted to receive the location-related message, the transaction server including a location-related message decoder for determining the location-related identifier encoded within the location-related message, a transaction authorization system for determining whether the pre-specified location comprises the location identified by the location-related identifier, and a transaction processor for conducting the location-dependent transaction if the transaction authorization system determines the pre-specified location comprises the location identified by the location-related identifier; and a location-related message transmit facility for transporting the location-related message from the verification server to the transaction server.

In yet another preferred embodiment, the invention provides a transaction authorization system for authorizing a transaction between a user and a transaction server if the user is in a pre-specified location, the system comprising: a location verification server for receiving a telephone call comprising a location verification request from a user computer desiring authorization to conduct a transaction with a transaction server, the location verification server including a location identification system for obtaining a location-related identifier associated with the user computer, a user identification system for obtaining a user identifier of the user associated with the location verification request, a clock capable of generating a timestamp associated with the location verification request and a message constructor for encoding the location-related identifier, the user identifier and the timestamp into a location verification message; and a transaction authorization server adapted to process a location verification message, the transaction authorization server including a message decoder for decoding the location-related identifier, the user identifier and the timestamp encoded within the location verification message, and a transaction authorization system for authorizing a transaction for the user identified by the user identifier if the pre-specified location comprises the location identified by the location-related identifier and the timestamp is less than a predetermined age; and a message transmit facility for transporting the message from the verification server to the transaction server.

In a further preferred embodiment, the invention provides a transaction authorization system for authorizing a transaction between a user and a transaction server if the user is in a pre-specified location, the system comprising: a location verification server for receiving a telephone call comprising a location verification request from a user computer desiring authorization to conduct a transaction with a transaction server, the location verification server including a location identification system for obtaining call identification information, the call identification information comprising information associated with the location of the call origin, a location code generator for generating a location-related identifier based, at least in part, upon the call identification information, a user identification system for obtaining a user identifier of the user associated with the location verification request, a clock capable of generating a timestamp associated with the location verification request and a message constructor for encoding the location-related identifier, the user identifier and the timestamp into a location verification message; and a transaction authorization server adapted to process a location verification message, the transaction authorization server including a message decoder for decoding the location-related identifier, the user identifier and the timestamp encoded within the location verification message and a transaction authorization system for authorizing a transaction for the user identified by the user identifier if the pre-specified location comprises the location identified by the location-related identifier and the timestamp is less than a predetermined age; and a message transmit facility for transporting the message from the verification server to the transaction server.

In yet a further preferred embodiment, the invention provides a transaction authorization system for authorizing a transaction between a user and a transaction server if the user is in a pre-specified location, the system comprising: a location verification server for receiving a telephone call comprising a location verification request from a user computer desiring authorization to conduct a transaction with a transaction server, the location verification server including a location identification system for obtaining call identification information, the call identification information comprising information associated with the location of the call origin, a location code generator for generating a location-related identifier based, at least in part, upon the call identification information, a user identification system for obtaining a user identifier of the user associated with the location verification request, a clock capable of generating a timestamp associated with the location verification request, and a message constructor for encoding the location-related identifier, the user identifier and the timestamp into a location verification message, the message constructor being adapted to incorporate an message authentication sequence within the message; a message transmitter for transmitting the location verification message to the user computer; and a transaction authorization server adapted to process a location verification message, the transaction authorization server including a message receiver for receiving the location verification message from the user computer, a message decoder for decoding the location-related identifier, the user identifier and the timestamp encoded within the location verification message, the message decoder being adapted to reject the message if the message authentication sequence reflects that the message has been altered since it had been encoded by the message constructor, and a transaction authorization system for authorizing a transaction for the user identified by the user identifier of a non-rejected message if the pre-specified location comprises the location identified by the location-related identifier and the timestamp is less than a predetermined age.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. It should be understood that the invention is not limited to the precise arrangement and instrumentality shown in these figures, and the drawings are neither necessarily to scale, nor do they contain particularized details of implementation, but rather, the emphasis of the drawings is placed upon illustrating principles of the invention.

FIG. 1 is a schematic representation of one layout for device connections to practice the present invention.

FIG. 2 is a high level communications and process flow diagram of a first embodiment of the location verification system;

FIG. 3 is a high level communications and process flow diagram of a second embodiment of the location verification system;

FIG. 4 is a high level communications and process flow diagram of a third embodiment of the location verification system;

FIG. 5 is a high level communications and process flow diagram of a fourth embodiment of the location verification system;

FIG. 6 is a high level communications and process flow diagram of a fifth embodiment of the location verification system;

FIG. 7 is a high level communications and process flow diagram of a sixth embodiment of the location verification system;

FIG. 8a is a high level communications and process flow diagram of one variation of a seventh embodiment of the location verification system;

FIG. 8b is a high level communications and process flow diagram of another variation of a seventh embodiment of the location verification system;

FIG. 8c is a high level communications and process flow diagram of yet another variation of a seventh embodiment of the location verification system;

FIG. 8d is a high level communications and process flow diagram of still another variation of a seventh embodiment of the location verification system.

FIG. 9 is a schematic representation illustrating a device connection layout which includes a transponder.

### DETAILED DESCRIPTION OF THE PREFERRED EMBODIMENTS

Reference will now be made in detail to the preferred embodiments of the present invention, examples of which are illustrated in the accompanying drawings.

Generally, the present invention is a location verification system for a network user to permit a network user to conduct a location-specific transaction with a transaction server. In other words, the present invention may be used to control access based, at least in part upon the location of the user. The access control may be on a system-wide basis, or may be as specific as the conduct of a specific transaction—permitting the user to conduct certain transactions while denying the user permission to conduct other transactions.

The expression “transaction”, as used herein, is intended to be interpreted in conformity with its broadest ordinary meaning. Examples of transactions that are contemplated include, without limitation, purchasing of information and/or content for immediate delivery, purchase of information, content and/or goods for later delivery, downloading of software, audio, video and/or multimedia, gaming, gambling, chat, voice and video applications which include upstream and/or downstream exchange of information, asp-type application access, client-server access, or any other type of transaction that may be carried out over a wired or wireless network.

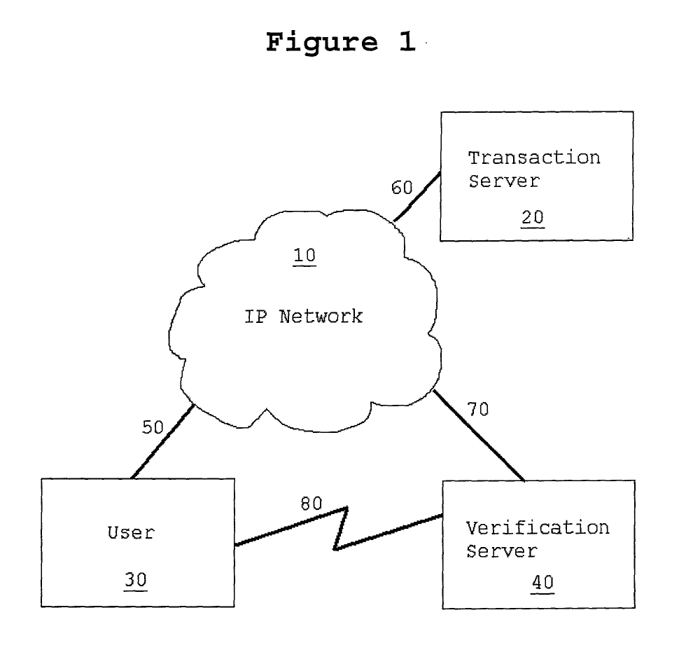

Turning first to FIG. 1, the system consists of three main communicating entities, a transaction server 20, a user 30 and a verification server (VS) 40. The system permits the user 30 to conduct transactions with the transaction server (TS) 20 if the verification server 40 can verify that the user 30 is located in (or outside) a pre-specified location. It will be understood by those skilled in the art that the verification server and the transaction server may be separate machines running separate software or may be housed in a single machine running separate software or a single software program which performs both the verification server functionality and the transaction server functionality. In the latter embodiment, the “messages” described below between the verification server and the transaction server may be in the form of internal software communication such as function calls between the verification server functionality and the transaction server functionality. It will also be understood by those skilled in the art that a “pre-specified” location includes, e.g., either a location that is on a list of authorized locations or a location that meets a set of rules defining authorized locations.

In one configuration, the user 30, the transaction server 20 and the verification server 40 are connected to an IP network 10 such as the Internet via communications links 50, 60 and 70 respectively. The user 30 is also able to connect to the verification server 40 via an alternative communications medium 80. The alternative communications medium 80 connecting the user 30 and the verification server 40 must permit the verification server to obtain a location-related information associated with the location of the user 30. The alternative communications medium 80 may, for example, be a telephone network permitting connection between the user 30 and the verification server 40 using modems over a dial-up connection.

Typically, but not necessarily, communications links 50, 60 and 70 will be higher speed connections than the alternative communications medium 80. The characteristics of the IP network 10, however, is not required to provide location-related information associated with the user 30.

Generally a user 30 desiring to conduct a transaction provided by the transaction server 20 first establishes a location identifiable connection via communications medium 80 with the verification server 40. The verification server 40 identifies the location of the user 30, and provides a location identification to the transaction server 20. Preferably the communications medium 80 may be a telephone connection that provides an Automatic Number Identification (ANI) providing at least an area code to the verification server 40.

In one embodiment, the user 30 uses a computer with a modem (not shown) to dial in to the verification server 40 via the communications medium 80, and the verification server 40 determines the ANI related to the call. The user 30 additionally connects the local computer to the transaction server 20, for example, via an IP network 10 using a broadband links 50 and 60. While the verification server 40 and the transaction server 20 are connected to the user's computer 30 the verification server 40 and the transaction server 20 may communicate over IP network 10 thereby permitting the transaction server 20 to receive information from the verification server 40 relating to the location of the user's computer 30.

In another embodiment, the user 30 uses a computer with a modem (not shown) to dial in to the verification server 40; and the verification server 40 determines the ANI related to the call as well as an identifier relating to the user 30. The verification server 40 provides the ANI and the identifier to the transaction server 20, preferably including a time stamp as well. The user 30 subsequently connects the local computer to the transaction server 20, for example, over IP network 10 using broadband links 50 and 60. The information provided by the verification server 40 to the transaction server 20 enables the transaction server to have information relating to the location of the user's computer 30.

In yet another embodiment, the user 30 uses a computer with a modem (not shown) to dial in to the verification server 40; and the verification server 40 determines the ANI related to the call. The verification server 40 then provides to the user 30 or the user's computer an encoded and/or encrypted message containing information relating to the user's location and preferably also containing an error detection code and a time-stamp. The user 30 subsequently connects the local computer to the transaction server 20, for example, via an IP network 10 using broadband links 50 and 60, and provides to the transaction server 20 the message it received from the verification server 40. The transaction server 20 decodes and/or decrypts the message, and thereby obtains information relating to the location of the user's computer 30.

The verification server 40 preferably would be able to identify the location of the user's computer 30, and additionally retrieve computer-identifying information (such as a hardware or software serial number) from the user's computer 30 that will add a layer of authentication to the transaction server 20, which would have access to that same computer-identifying information.

Although the transaction server 20 and the verification server 40 are designated separately in the Figures, the two servers may operate on a single computer network or a single computer, or could be integrated into the same software system.

First Embodiment: Providing Tamper-Resistant Access Token to User

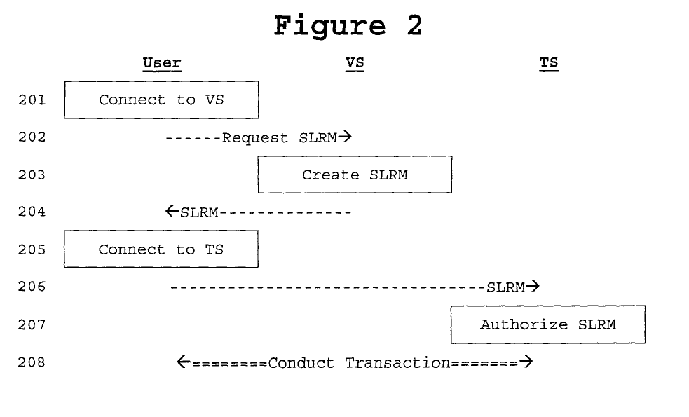

Turning first to FIG. 2, a user desiring to engage in a transaction with a transaction server connects first to a verification server as shown on step 201. In a preferred embodiment, the medium of connection to the verification server must permit the verification server to obtain a location-related identifier associated with the location of the user. The user may, for example, connect to the verification server using a modem over a dial-up telephone connection.

Upon establishing a connection to the verification server, the user may request a secure location-related message (SLRM) that the user can subsequently provide to a transaction server. The term secure as used in connection with the SLRM refers to a tamper resistance mechanism that inhibits user tampering with the message. In this embodiment the user obtains the SLRM, and thus, some tamper resistance mechanism is necessary to prevent the user from fraudulently modifying the SLRM. These will be discussed in more detail below.

The verification server has a decoder (not shown) that obtains a location-related identifier associated with the location of the connected user. Where the user has connected to the verification server via a telephone connection, the decoder may utilize a feature of the telephone network called Automatic Number Identification (ANI). The ANI feature allows the system to determine, at a minimum, an area code and exchange of a caller, and in many instances, the entire originating telephone number. The decoder can be any caller-ID type device, or any device capable of obtaining the ANI associated with an incoming telephone call. The location-related identifier may be the ANI or incoming call number, or it may be some other identifier of the location represented by the ANI or incoming call number (such as, for example, the name of a city and/or state, or an arbitrary number assigned to represent a geographic, political or jurisdictional region.

The verification server then assembles a secure location-related message (SLRM) as shown step 203. The SLRM preferably contains, at least, the location-related identifier, and may also contain other information such as, the ANI or incoming call number, the date and time of the call or request for an SLRM, and an identifier of the verification server that generated the SLRM. A tamper resistance mechanism is then utilized to secure the information. Depending on the level of tamper resistance desired, many tamper resistance means are well known. For example, for low security applications, a simple cyclical redundancy check or checksum embedded in the SLRM may suffice. Preferably, however, the verification server and the transaction server with which the user desires to transact share a encryption system that would permit the SLRM to be encrypted. Once encrypted, the SLRM would, essentially, be tamper proof. The encryption could be done by any method, such as DES, or the public/private key method proliferated by RSA.

In a preferred embodiment, the identifier of the verification server would be again appended to the encrypted SLRM. This would permit the transaction server receiving the SLRM to determine the verification server generating the SLRM without having to first decrypt or decode the SLRM. This would enable such a preferred system to maintain differing means of security for each verification server, further reducing the ability to tamper.

It is also contemplated that the user may be required to identify a preferred transaction and/or transaction server when requesting an SLRM in step 202. As will be apparent to persons of skill in the art, providing this information in step 202 would enable further security by permitting the verification server to maintain differing means of security for different transaction servers and/or for different transactions. (In the case of encoding based upon transaction, a clear-text indication of the transaction type would preferably be appended to the SLRM. In the case of encoding based upon a transaction server, no additional clear-text would be necessary as a transaction server would know its own identity.) This would further reduce the chances of tampering with the SLRM or attempts to fraudulently create an SLRM.

The verification server may also determine an identifier for the user. In one embodiment an ANI that is sufficiently specific to uniquely identify the calling location may be used as a user identifier. In an alternative embodiment, the user may supply the identification in connection with its request for an SLRM shown on step 202. Alternatively, the user may automatically supply identifying information or may be prompted for such information. As is commonly known, identification information may additionally require that a password or some other form of authentication. The user could type or respond to a prompt, or alternatively, an automated process could take place to obtains the user identification (and preferably a security token such as a password) from the calling system.

Once the SLRM is created, it is returned to the user as shown in step 204. The SLRM may be represented by alpha-numeric characters that the user can “cut,” and later “paste,” or that the user can write down. It could also be provided in the form of a data block or file placed in a volatile or non-volatile memory of the user's system. The user may, but need not, disconnect from the verification server.

Once it has the SLRM, the user may then connect to the transaction server as shown on step 205. The user need not concern itself with using a medium of connection that permits the obtaining of a location-related identifier associated with the location of the user; rather, the user could use, for example, a cable modem, DSL or other non-localizable connection to connect to the transaction server. Such a connection may be made over the Internet, or other computer network. After connecting to the transaction server, the user will provide the SLRM to the transaction server as shown in step 206. The user may be prompted to type the SLRM by the transaction server, or the transaction server may automatically attempt to obtain it from the data block or file where it may have been placed by the verification server.

Upon receiving the SLRM, the SLRM is authorized by the transaction server as shown in step 207. To authorize the SLRM, it is first decoded by a decoder. The decoder preferably checks the tamper resistance mechanism to make sure that there are no signs of tampering. In the event that the SLRM has been tampered with, or has been corrupted by transmission, the transaction server may request that it be reentered, or may simply abort the connection.

The next step in authorizing the SLRM is to determine the location-related identifier. It will be apparent to one of skill in the art that any process used to encode or encrypt the SLRM by the verification server needs to be reversed.

Finally, in authorizing the SLRM a transaction authorization system, which can be implemented in software, preferably compares the location-related identifier to a set of permitted location identifiers, and authorizes the transaction if the location-related identifier is one of the permitted locations. Alternatively, the system could be set up to maintain a set of non-permitted location identifiers, and the transaction authorization system authorizes the transaction if the location-related identifier is not in the set of non-permitted location identifiers.

It will be apparent to one of skill in the art that, if the SLRM contains transaction-type information, the transaction authorization system could (and preferably would) maintain separate sets of permitted or non-permitted location identifiers for the various transaction types that would be requested.

As mentioned above, the SLRM may contain identifying information of the user, and thus, the user preferably would not need to provide it again to the transaction server. If the user's identifying information, however, is not contained within the SLRM, the user may additionally have to supply its identifying information to the transaction server. The transaction server can determine this after having decoded the SLRM. The transaction authorization system can additionally make decisions based upon knowing the user as well as the location-related identifier and any other information contained in the SLRM.

In the event that the transaction authorization system authorizes the transaction, the transaction server and the user may thereafter conduct one or more transactions as shown in step 208. By way of illustration, if the apparatus of the present invention were implemented for a gambling system, the transaction authorization system could permit gambling transactions from some jurisdictions, while permitting only those “playing for fun” transactions from others. Moreover, if the gambling system were only licensed to have certain games in certain regions regardless of whether the play was for fun or money, the transaction authorization system could prevent access to those gaming transactions outside of a given region. The resolution of the transaction authorization system is limited only by the resolution specificity of location that can be derived from the medium of connection to the verification server.

Second Embodiment: Providing Tamper-Resistant Expiring Access Token to User

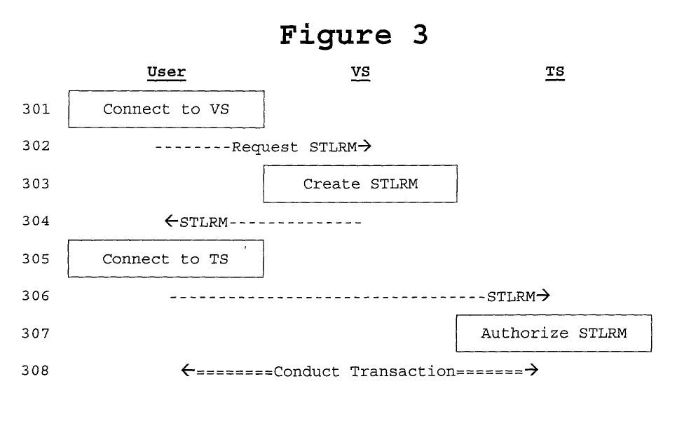

Turning now to FIG. 3, another embodiment of the location identification system is shown. As in the previous embodiment, a user desiring to engage in a transaction with a transaction server connects first to a verification server as shown on step 301. At step 302, the user requests a secure time-stamped location related message (STLRM). An STLRM differs from an SLRM in that it must contain a time stamp, which could optionally be contained in an SLRM.

A time stamp would preferably contain a representation of the time that it was created. In addition, a lifetime or expiration time may also be included in the time stamp. Alternatively, the time stamp could comprise a representation of a time of expiration.

At step 303, the STLRM is created in much the same way as it the SLRM, except that a clock source must be used to obtain a relative or absolute time. The clock source need not provide an absolute time, but should reflect the passage of time as necessary to determine whether a user's session has expired. Once created and secured, the STLRM is provided to the user at step 304, and the user thereafter connects to the transaction server at step 305, and provides the STLRM to the transaction server at step 306.

In addition to the functionality of the embodiment described in relation to FIG. 2, step 207, in authorizing the STLRM at step 307 the decoder must decode the time-stamp, and the transaction authorization system may evaluate the time-stamp to whether it the STLRM is still valid. Thus, the STLRM, unlike the SLRM, can expire, for example, in an hour, a day, or even in just a few minutes or seconds. Using an STLRM instead of an SLRM would prevent a user from obtaining a location-related message and then simply traveling to another jurisdiction prior to using it.

The time stamp could itself represent its expiration, which could be fixed or relative to some other event, or, the recipient of the time stamp could determine its expiration, which can be based upon a fixed period, or could be specific or related to one or more other events or elements of the user's desired transaction, for example, the expiration could depend upon one or more of the following: the verification server, the transaction server, the user (if known), the transaction attempted, and/or the location-related identifier determined by the verification server.

As above, in the event that the transaction authorization system authorizes the transaction (thereby determining that the time-stamp is un-expired), the transaction server and the user may thereafter conduct one or more transactions as shown in step 308.

Third Embodiment: Providing Access Token for User to Transaction Server

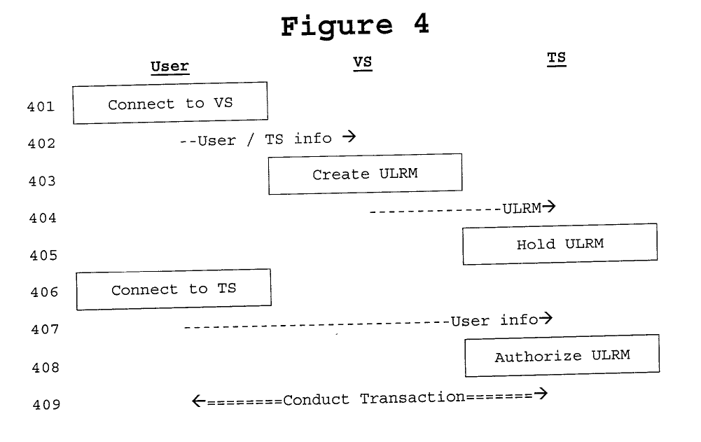

Turning now to FIG. 4, another embodiment of the location identification system is shown. As in the previous embodiments, a user desiring to engage in a transaction with a transaction server connects first to a verification server as shown on step 401.

At step 402, the user identifies itself and the transaction server with which it desires to connect. In step 403, the verification server creates a user and location-related message that comprises both a user identification and location-related information (ULRM). As above, the ULRM may contain additional information such as, for example, an identifier of the creating verification server and/or a time-stamp. The ULRM may be secured with a tamper resistant mechanism, however, since it is not provided to the user, the need for such security is reduced. At step 404, the verification server provides the ULRM to the transaction server with which the user desires to connect. As will be apparent to one of skill in the art, the protocol between the verification server and the transaction server can provide a desired level of certainty that the ULRM is authentic.

Once received, the URLM is analyzed to determine the related user identification. Once associated with the related user identification, the URLM is stored by the transaction server as is shown in step 405.

At step 406, the user is shown connecting to the transaction server, and at step 407, the user provides its user identification to the transaction server.

In step 408, the authorization of the ULRM consists of locating the ULRM associated with the received user identification, and then comparing to make sure that the location-related information is appropriate. As above, any additional know information may be used, such as, for example, a time-stamp, a transaction type, or even the identify of the verification server. In this manner the authorize ULRM process shown at step 408 may determine whether it is appropriate to authorize the user and the transaction server to conduct transactions. If such authorization is appropriate, the user and the transaction server may conduct transactions as shown in step 409.

Fourth Embodiment: Providing Expiring Access Token for User to Transaction Server

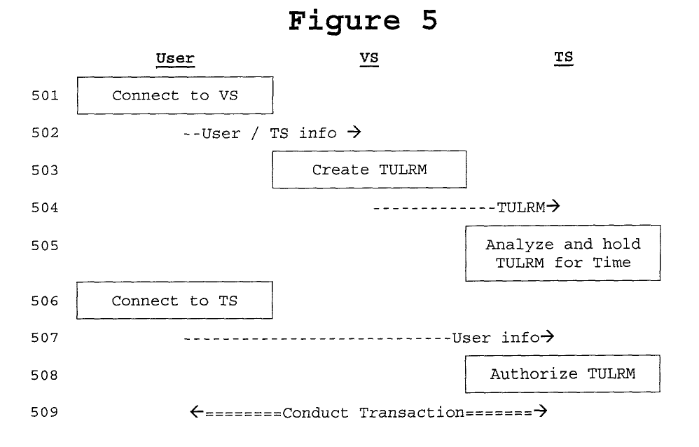

Turning next to FIG. 5, yet another embodiment of the location identification system is shown. As in the previous embodiments, a user desiring to engage in a transaction with a transaction server connects first to a verification server as shown on step 501. At step 502 the user identifies itself and the transaction server with which it desires to connect; at step 503, the verification server creates a time-stamped user and location-related message (TULRM) that comprises a time stamp, as well as user identification and location-related information. As above with other LRMs, the TULRM may contain additional information such as, for example, an identification of the creating verification server. The TULRM may be secured with a tamper resistant mechanism, however, since it is not provided to the user, the need for such security is reduced. At step 504, the verification server provides the TULRM to the transaction server. As will be apparent to one of skill in the art, the protocol between the verification server and the transaction server can provide a desired level of certainty that the ULRM is authentic.

Once received by the transaction server, the TURLM is analyzed to determine the related user identification and the time stamp and then held as shown in step 505. Specifically, the time stamp is used to determine first, whether the TULRM is valid (i.e., unexpired). If the TULRM is unexpired, it is associated with the related user identification, and is preferably stored by the transaction server until its expiration and then discarded. Alternatively, the TULRM may be retained after its expiration, but either flagged as expired or otherwise being made unusable to conduct transactions. In the event that the TULRM is not discarded immediately after expiration, the system will be able to more specifically notify a user attempting to conduct a transaction with the transaction server that it has been refused due to an expired TULRM.

At step 506, the user is shown connecting to the transaction server, and at step 507, the user provides its user identification to the transaction server.

In step 508, the authorization of the TULRM consists of locating the stored TULRM associated with the received user identification, and then comparing to make sure that the time stamp and location-related information is appropriate.

As above, any additional know information may be used, such as, for example, a transaction type, or even the identify of the verification server. In this manner the authorize ULRM process shown at step 508 may determine whether it is appropriate to authorize the user and the transaction server to conduct transactions. If such authorization is appropriate, the user and the transaction server may conduct transactions as shown in step 509.

It should be noted that this fourth embodiment has been described without regard for whether the user remains connected to, or disconnects from the verification server. In one variation of this, or many of the embodiments presented herein, the invention would require that the user remains connected to the verification server, and the verification server would send a disconnect message (not shown) to the transaction server upon detecting a disconnection from the user. When employing such a variation, the transaction server preferably either would suspend the conduct of the transaction until the verification sever indicated a reconnection, or would simply discontinue the conduct of the transaction as a result of the disconnect message.

Fifth Embodiment: Providing Access Token for User to Transaction Server, Transaction Server Connects to User

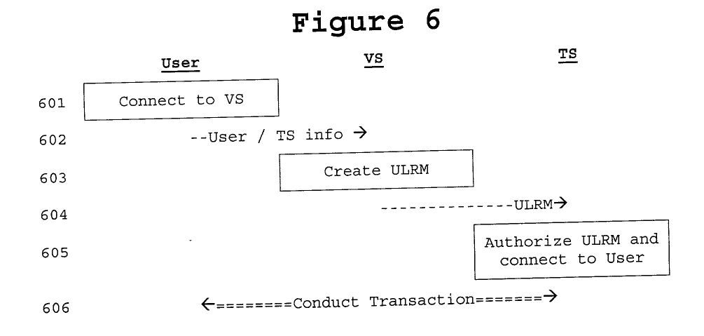

Turning now to FIG. 6, another embodiment of the location identification system is shown. As in the previous embodiments, a user desiring to engage in a transaction with a transaction server connects first to a verification server as shown on step 601. At step 602 the user identifies itself and the transaction server with which it desires to connect at step 603, the verification server creates a ULRM that comprises user identification and location-related information. As above with other LRMs, the ULRM may contain additional information such as, for example, an identification of the creating verification server or a time stamp. The ULRM may be secured with a tamper resistant mechanism, however, as above, since the ULRM is not provided to the user, the need for such security is reduced. At step 604, the verification server provides the ULRM to the transaction server. As will be apparent to one of skill in the art, the protocol between the verification server and the transaction server can provide a desired level of certainty that the ULRM is authentic.

In step 605, the authorization of the ULRM consists of checking the tamper resistance mechanism, if any, and then decoding the ULRM to determine the user and location-related identifiers. Finally, in authorizing the ULRM a transaction authorization system, which can be implemented in software, preferably compares the location-related identifier to a set of permitted location identifiers, and authorizes the transaction if the location-related identifier is one of the permitted locations. Alternatively, the system could be set up to maintain a set of non-permitted location identifiers, and the transaction authorization system authorizes the transaction if the location-related identifier is not in the set of non-permitted location identifiers. It will be apparent to one of skill in the art that, if the ULRM contains transaction-type information, the transaction authorization system could (and preferably would) maintain separate sets of permitted or non-permitted location identifiers for the various transaction types that would be requested.

If the transaction is authorized, the transaction server at step 605 connects to the user. This can be accomplished by having the user use connection information as its user identifier in step 602, or alternatively, having the transaction server maintain connection information for the users permitted conduct a transaction using this method. In either event, once the transaction server connects to the user, at step 606, the user and transaction server may conduct one or more transactions.

Sixth Embodiment: Using User Computer As Router for Providing Access Token to Transaction Server

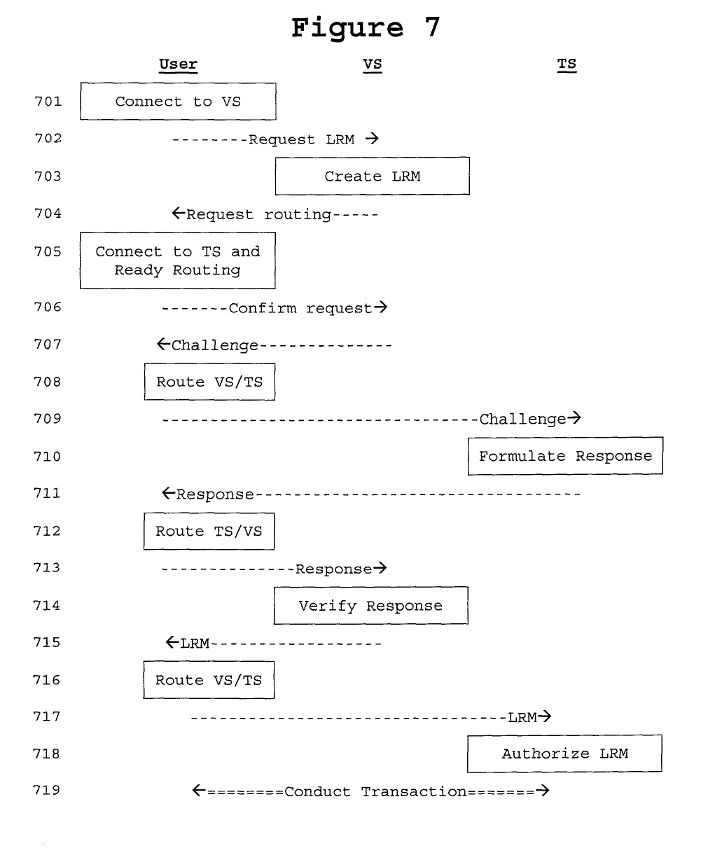

Turning next to FIG. 7, another embodiment of the location identification system is shown. As in the previous embodiments, a user desiring to engage in a transaction with a transaction server connects first to a verification server as shown on step 701. At step 702 the user requests an LRM. At step 703, the verification server creates a LRM that comprises location-related information. The LRM may, but need not contain additional information, and may be secured with a tamper resistant mechanism.

This embodiment differs substantially from the previous embodiments in that at step 703, the verification server requests routing—in other words, that the user create a “channel” between the verification server and the transaction server with which the user desires to engage in a transaction. In response to the request for routing at step 704, at step 705 the user connects to the transactions server with which it desires to conduct a transaction and internally prepares to route communications between the verification server and the transaction server. The user confirms to the verification server that the routing is ready at step 706.

At step 707 the verification server sends a transaction server-bound challenge to the user, which the user receives and routes at step 708, and forwards on to the transaction server at step 709. At step 720, the transaction server would formulate a response to the challenge, and at step 711, would provide the verification server-bound response back to the user. The user would receive and route the response at step 712, and forward it on to the verification server at step 713. The challenge, as will be apparent to one of skill in the art, would preferably be of a nature that only a known transaction server would be able to respond correctly. For example, the challenge could consist of a random number that has been encrypted using a channel protection key known only to the verification server and the transaction server. The transaction server could decrypt the number, add one and re-encrypt it as a response. Although the user could “see” the exchange, it would not be able to make changes that would be accepted by the verification server.

Once the verification server is satisfied of the authenticity of the channel to the transaction server by verification of its response at step 714, it would preferably use the same channel protection key to transmit the LRM to the user at step 715. The user would receive and route the LRM at step 716, and provide it to the transaction server at step 717.

In step 718, the authorization of the LRM consists of determining whether the location-related information is appropriate. As above, any additional know information may be used, such as, for example, a time-stamp, the user identity, a transaction type, or even the identify of the verification server. In this manner the authorize LRM process shown at step 718 may determine whether it is appropriate to authorize the user and the transaction server to conduct transactions. If such authorization is appropriate, the user and the transaction server may conduct transactions as shown in step 719.

Seventh Embodiment: Providing Access Token for User to Transaction Server and Monitoring Connection

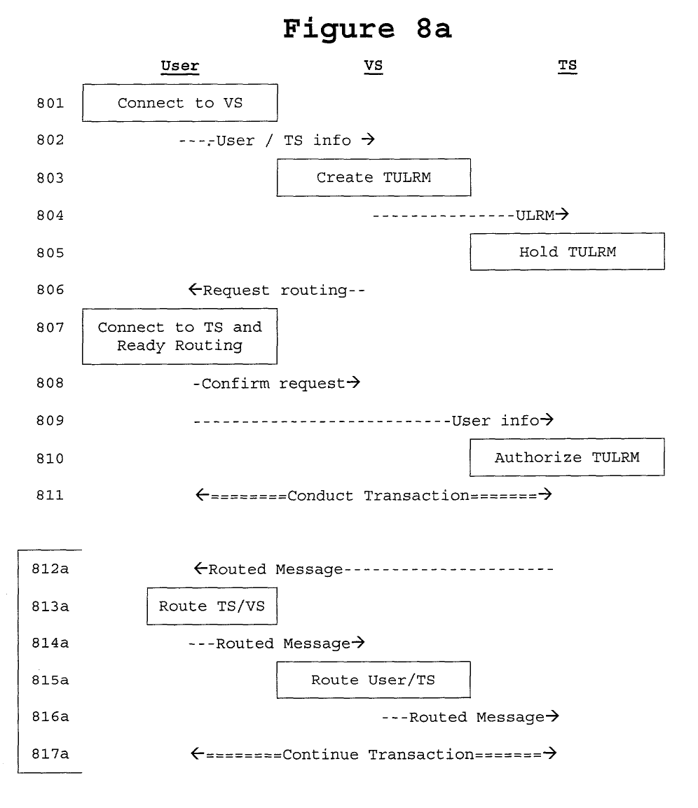

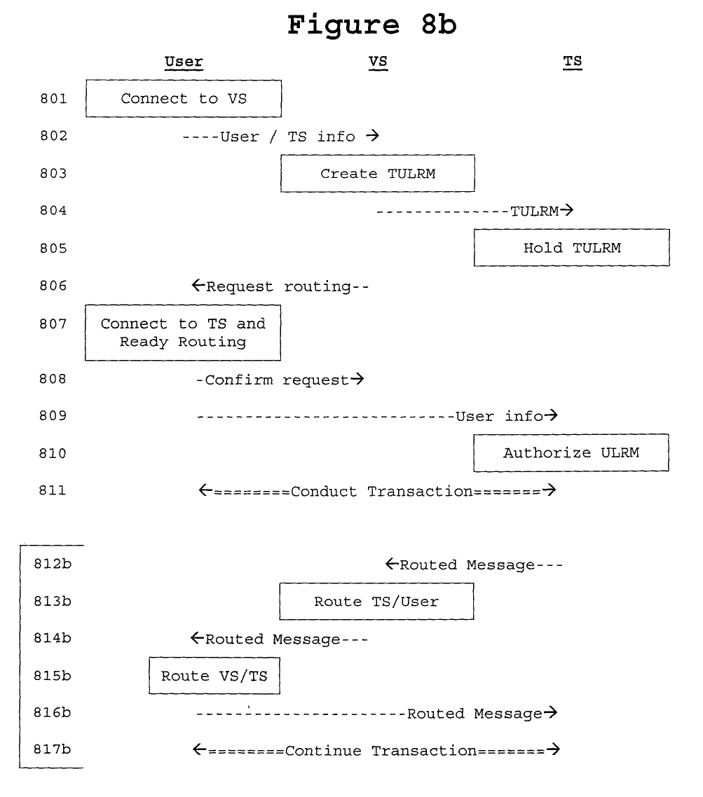

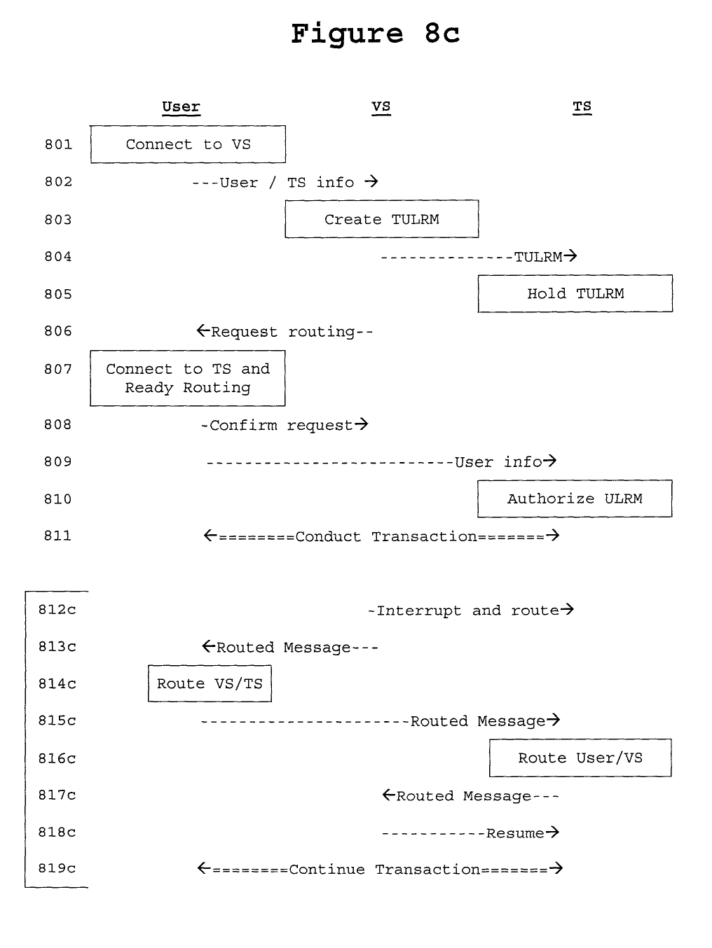

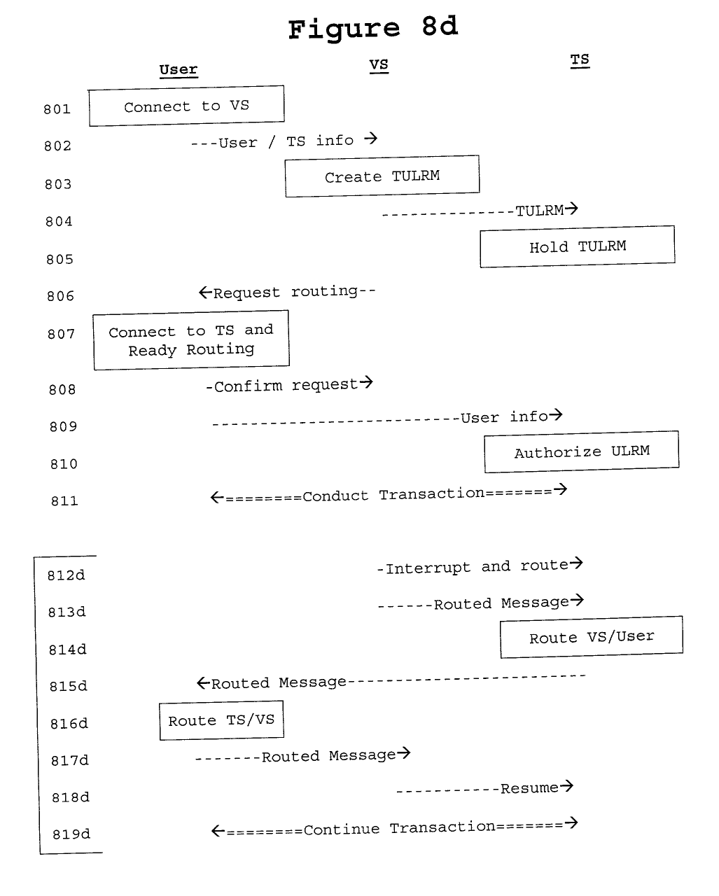

FIGS. 8a through 8d represent variations of another embodiment of the location identification system is shown. In FIGS. 8a through 8d steps 801 to 811 are identical, as follows. As in the previous embodiments, a user desiring to engage in a transaction with a transaction server connects first to a verification server as shown on step 801. At step 802, the user identifies itself and the transaction server with which it desires to connect, and at step 803, the verification server creates a TULRM that comprises a time stamp and user and location-related information. The TULRM may, but need not contain additional information, and may, but need not be secured with a tamper resistant mechanism.

As in the fourth embodiment above, at step 804, the verification server provides the TULRM to the transaction server. Once received by the transaction server, the TURLM is analyzed to determine the related user identification and the time stamp and then held as shown in step 805.

As in the previous embodiment, the verification server requests routing to the transaction server at step 806. In response to the request for routing, at step 807 the user connects to the transactions server with which it desires to conduct a transaction and internally prepares to route communications between the verification server and the transaction server. The user confirms to the verification server that the routing is ready at step 808.

At step 809, the user provides its user identification to the transaction server. At step 820, (as in step 508 in the fourth embodiment above) the authorization of the TULRM consists of locating the stored TULRM associated with the received user identification, and then comparing to make sure that the time stamp and location-related information is appropriate. As above, any additional know information may be used, such as, for example, a transaction type, or even the identify of the verification server. In this manner the authorize TULRM process shown at step 820 may determine whether it is appropriate to authorize the user and the transaction server to conduct transactions. If such authorization is appropriate, the user and the transaction server may conduct transactions as shown in step 811.

With reference now to FIG. 8a, at a time determined by the transaction server during the conduct of the transaction between the transaction server and the user, the transaction server stops conducting the transaction and at step 812a the transaction server provides a verification server-bound routed message to the user. In response the user receives and routes the routed message at step 813a, and provides it to the verification server at step 814a. Similarly, in response the verification server receives and routes the routed message at step 815a, and provides it to the transaction server at step 816a. If the transaction server receives the routed message from the verification server, it continues the transaction with the user at 817a. If the routed message is not received by the transaction server, the conduct of the transaction is not resumed.

This “round trip” message confirms to the transaction server that the user is still connected to the verification server. Especially where the connection between the verification server and the user is a telephone call, this would be an effective means for preventing the user from attempting to change locations after the TULRM is authorized.

The variation shown in FIG. 8b, like FIG. 8a, also requires that the user maintain its connection to the verification server during the conduct of the transactions. At a time determined by the transaction server during the conduct of the transaction between the transaction server and the user, the transaction server stops conducting the transaction and at step 812b a routed message is provided by the transaction server to the verification server. In response the verification server receives and routes the routed message at step 813b, and provides it to the user at step 814b. Similarly, in response the user receives and routes the routed message at step 815b, and provides it to the transaction server at step 816b. If the transaction server receives the routed message from the verification server, it continues the transaction with the user at 817b. As above, if the routed message is not received by the transaction server, the conduct of the transaction is not resumed.

FIGS. 8c and 8d show a variation of the seventh embodiment wherein the verification server, not the transaction server may randomly or periodically verify that the “round trip” exists, thereby verifying the continued connection, and thus location of the user. In FIG. 8c, at step 812c the verification server sends and interrupt and route command to the transaction server, which causes the transaction server to suspend the conduct of the transaction. The verification server sends a routed message to the user at step 813c. The user receives and routes the routed message at 814c, and at step 815c provides the routed message to the transaction server over the previously established channel. The transaction server, similarly, receives and routes the routed message at step 816c and provides the routed message to the verification server at step 817c. If the verification server receives the routed message, it preferably sends a resume to the transaction server at step 818c, whereupon the transaction server continues the transaction with the user at step 819c. As with the above variations, if the round trip is not completed, the suspended transaction will not be resumed.

In FIG. 8d, at step 812d the verification server sends and interrupt and route command to the transaction server, which causes the transaction server to suspend the conduct of the transaction. The verification server sends a routed message to the transaction server at step 813d. The transaction server receives and routes the routed message at 814d, and at step 815d provides the routed message to the user. The user, similarly, receives and routes the routed message at step 816d and provides the routed message to the verification server at step 817d. As above, if the verification server receives the routed message, it preferably sends a resume to the transaction server at step 818d, whereupon the transaction server continues the transaction with the user at step 819d. As above, if the round trip is not completed, the suspended transaction will not be resumed.

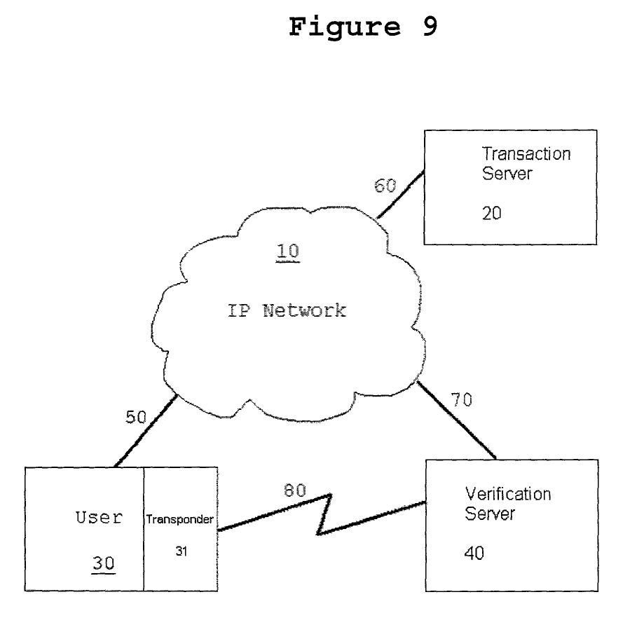

FIG. 9 is a schematic representation illustrating a device connection layout which includes a transponder 31. The transponder 31 may be connected to the user computer or may be integrated with it. In accordance with the present embodiment, communication between the user, the verification server, and the transaction server can occur in much the same manner as is shown in FIGS. 2 through 8d, except that the request for an LRM includes information from the transponder which identifies the user's location. In this respect, the description of FIGS. 2 through 8d above is incorporated herein. In accordance with the present embodiment, the verification server need not use ANI to verify the user's location. The information may be in the form of the user's longitude and latitude as determined by the transponder 31, and is preferably encrypted. The transponder 31 may comprise, e.g., a GPS transponder or other suitable location-determining device. The information identifying the user's location may be communication to the verification server by the user computer or directly by the transponder. The encryption may be done by any method, such as DES, random number generator, or the public/private key method proliferated by RSA.

The present invention has been described with respect to the foregoing seven distinct embodiments and variations, but it is important to note that almost infinite variations of the elements presented, and combinations of the presented elements with other elements are contemplated. Thus, while the invention has been particularly shown and described with reference to the preferred embodiments thereof, it will be understood by those skilled in the art that various changes in form and details may be made therein without departing from the spirit and scope of the invention.

The embodiments of the invention in which an exclusive property or privilege is claimed are defined as follows:

1. A transaction authorization system for authorizing a transaction between a user computer and a transaction processor if the user computer is in a pre-specified location, the system comprising:
a location verification server for receiving a location verification request from a user computer desiring authorization to conduct a transaction with a transaction server, the location verification server including:
a location identification system for obtaining a location-related identifier associated with the source of the location verification request; and
a message constructor for encoding the location-related identifier into a message;
a transaction server adapted to receive the message, the transaction server including:
a message decoder for decoding the location-related identifier encoded within the message; and
a transaction authorizer system for authorizing a transaction between the user computer and the transaction processor if the pre-specified location comprises the location identified by the location-related identifier; and
a message transmit facility for transporting the message from the location verification server to the transaction server.

2. The transaction authorization system claimed in claim 1, wherein the location verification request from the user computer is made over a telephone network, and wherein the location-related identifier comprises at least a portion of the calling telephone number.

3. The transaction authorization system claimed in claim 2, wherein the user computer is connected to the transaction server via a first network, and the message transmit facility transports the message to the transaction server over the telephone network, via the user computer, and over the first network.

4. The transaction authorization system claimed in claim 2, wherein the verification server is connected to the transaction server via a second network, and the message transmit facility is adapted to transport the message to the transaction server over the second network.

5. The transaction authorization system claimed in claim 4, wherein the message transmit facility is adapted to transmit the message to the transaction server while the user computer is connected to the verification server via the telephone network.

6. The transaction authorization system claimed in claim 4, wherein the message transmit facility is adapted to transmit a disconnect message to the transaction server when the user computer ceases to be connected to the verification server via the telephone network.

7. The transaction authorization system claimed in claim 1, wherein the location-related identifier comprises an indication of the user's longitude and latitude as determined by a transponder.

8. The transaction authorization system claimed in claim 7, wherein the indication of the user's longitude and latitude is encrypted.

9. A transaction processing system for conducting a location-dependent transaction between a user and a transaction server if the user is in a pre-specified location, the system comprising:
a verification server for receiving an incoming telephone call from a user desiring to conduct a location-dependent transaction with a transaction server, the verification server including:
a decoder for obtaining a location-related identifier associated with the incoming telephone call; and
a location-related message constructor for encoding the location-related identifier into a location-related message;
a transaction server adapted to receive the location-related message, the transaction server including:
a location-related message decoder for determining the location-related identifier encoded within the location-related message;
a transaction authorization system for determining whether the pre-specified location comprises the location identified by the location-related identifier; and
a transaction processor for conducting the location-dependent transaction if the transaction authorization system determines the pre-specified location comprises the location identified by the location-related identifier; and
a location-related message transmit facility for transporting the location-related message from the verification server to the transaction server.

10. A transaction authorization system for authorizing a transaction between a user and a transaction server if the user is in a pre-specified location, the system comprising:
a location verification server for receiving a telephone call comprising a location verification request from a user computer desiring authorization to conduct a transaction with a transaction server, the location verification server including:
a location identification system for obtaining a location-related identifier associated with the user computer;
a user identification system for obtaining a user identifier of the user associated with the location verification request;
a clock capable of generating a timestamp associated with the location verification request; and
a message constructor for encoding the location-related identifier, the user identifier and the timestamp into a location verification message; and
a transaction authorization server adapted to process a location verification message, the transaction authorization server including:
a message decoder for decoding the location-related identifier, the user identifier and the timestamp encoded within the location verification message; and
a transaction authorization system for authorizing a transaction for the user identified by the user identifier if the pre-specified location comprises the location identified by the location-related identifier and the timestamp is less than a predetermined age; and
a message transmit facility for transporting the message from the verification server to the transaction server.

11. The transaction authorization system claimed in claim 8, wherein the location verification request from the user computer is made over a telephone network, and wherein the location identification system obtains at least a portion of the calling telephone.

12. The transaction authorization system claimed in claim 9, wherein the user computer is connected to the transaction server via a first network, and the message transmit facility transports the message to the transaction server over the telephone network, via the user computer, and over the first network.

13. The transaction authorization system claimed in claim 8, wherein the verification server is connected to the transaction server via a second network, and the message transmit facility is adapted to transport the message to the transaction server over the second network.

14. The transaction authorization system clamed in claim 11, wherein the message transmit facility is adapted to transmit the message to the transaction server while the telephone call is in progress between the user computer and the verification server.

15. The transaction authorization system claimed in claim 12, wherein the message transmit facility is adapted to transmit a disconnect message to the transaction server when the telephone call ceases to be in progress between the user computer and the verification server.

16. A transaction authorization system for authorizing a transaction between a user and a transaction server if the user is in a pre-specified location, the system comprising:
a location verification server for receiving a telephone call comprising a location verification request from a user computer desiring authorization to conduct a transaction with a transaction server, the location verification server including:
a location identification system for obtaining call identification information, the call identification information comprising information associated with the location of the call origin;
a location code generator for generating a location-related identifier based, at least in part, upon the call identification information;
a user identification system for obtaining a user identifier of the user associated with the location verification request;
a clock capable of generating a timestamp associated with the location verification request; and
a message constructor for encoding the location-related identifier, the user identifier and the timestamp into a location verification message; and
a transaction authorization server adapted to process a location verification message, the transaction authorization server including:
a message decoder for decoding the location-related identifier, the user identifier and the timestamp encoded within the location verification message; and
a transaction authorization system for authorizing a transaction for the user identified by the user identifier if the pre-specified location comprises the location identified by the location-related identifier and the timestamp is less than a predetermined age; and
a message transmit facility for transporting the message from the verification server to the transaction server.

17. The transaction authorization system claimed in claim 14, wherein the call identification information includes at least a portion of the calling telephone.

18. The transaction authorization system claimed in claim 15, wherein the user computer is connected to the transaction server via a first network, and the message transmit facility transports the message to the transaction server over the telephone network, via the user computer, and over the first network.

19. The transaction authorization system claimed in claim 14, wherein the verification server is connected to the transaction server via a second network, and the message transmit facility is adapted to transport the message to the transaction server over the second network.

20. The transaction authorization system clamed in claim 17, wherein the message transmit facility is adapted to transmit the message to the transaction server while the telephone call is in progress between the user computer and the verification server.

21. The transaction authorization system claimed in claim 18, wherein the message transmit facility is adapted to transmit a disconnect message to the transaction server when the telephone call ceases to be in progress between the user computer and the verification server.

22. A transaction authorization system for authorizing a transaction between a user and a transaction server if the user is in a pre-specified location, the system comprising:
a server comprising both a verification server and a transaction server, the location verification server comprising means for receiving a location verification request from a user computer desiring authorization to conduct a transaction with a transaction server;
a location identification system for obtaining a location-related identifier associated with the source of the location verification request; and,
a transaction authorizer system for authorizing a transaction between the user computer and the transaction processor if the pre-specified location comprises the location identified by the location-related identifier.

23. A transaction authorization system for authorizing a transaction between a user computer and a transaction processor if the user computer is in a pre-specified location, the system comprising:
a location verification server for receiving a telephone call comprising a location verification request from a user computer desiring authorization to conduct a transaction with a transaction server, the location verification server including:
a location identification system for obtaining call identification information, the call identification information comprising information associated with the location of the call origin;
a location code generator for generating a location-related identifier based, at least in part, upon the call identification information;
a user identification system for obtaining a user identifier of the user associated with the location verification request;
a clock capable of generating a timestamp associated with the location verification request; and
a message constructor for encoding the location-related identifier, the user identifier and the timestamp into a location verification message, the message constructor being adapted to incorporate an message authentication sequence within the message;
a message transmitter for transmitting the location verification message to the user computer; and
a transaction authorization server adapted to process a location verification message, the transaction authorization server including:
a message receiver for receiving the location verification message from the user computer;
a message decoder for decoding the location-related identifier, the user identifier and the timestamp encoded within the location verification message, the message decoder being adapted to reject the message if the message authentication sequence reflects that the message has been altered since it had been encoded by the message constructor; and
a transaction authorization system for authorizing a transaction for the user identified by the user identifier of a non-rejected message if the pre-specified location comprises the location identified by the location-related identifier and the timestamp is less than a predetermined age.
